(19) United States
(12) Patent Application Publication
(10) Pub. No.: US 2026/0282119 A1
(43) Pub. Date: Sep. 17, 2026

(54) SYSTEMS AND METHODS FOR ESTABLISHING BACKHAUL CONNECTIVITY DURING BROADBAND SERVICE OUTAGE

(71) Applicant: T-Mobile Innovations LLC, Overland Park, KS (US)

(72) Inventor: Micheol SEO, Greenwood Village, CO (US)

(21) Appl. No.: 19/076,119

(22) Filed: Mar. 11, 2025

(51) Int. Cl. H04W 76/10; H04W 48/20

(52) U.S. Cl. CPC H04W 76/10; H04W 48/20

(57) ABSTRACT

Systems and methods are provided for establishing a backhaul connection in a wireless network. Methods include determining that broadband internet connectivity for a plurality of user equipment (UEs) is abnormal. The methods further include determining that one or more UEs of the plurality of UEs have a backhaul cellular capability and transmitting a backhaul request token to a selected UE among the one or more UEs that have the backhaul cellular capability. In addition, the methods include receiving backhaul acceptance from the selected UE among the one or more UEs that has the backhaul cellular capability and establishing backhaul connectivity for the plurality of UEs via the selected UE that has the backhaul cellular capability.

### TECHNICAL BACKGROUND

Certain in-home devices and services, such as security devices and medical devices, require internet access to maintain operational status. Typically, such devices use Wi-Fi functionality for internet connectivity via a broadband service. In instances when the in-home internet is unavailable, the in-home devices are inoperative.

### OVERVIEW

Examples described herein include systems and methods for providing backhaul connectivity for in-home networks without additional hardware. An exemplary method includes determining that broadband internet connectivity for a plurality of user equipment (UEs) is abnormal; determining that one or more UEs of the plurality of UEs have a backhaul cellular capability; transmitting a backhaul request token to a selected UE among the one or more UEs that have the backhaul cellular capability; receiving backhaul acceptance from the selected UE among the one or more UEs that has the backhaul cellular capability; and establishing backhaul connectivity for the plurality of UEs via the selected UE that has the backhaul cellular capability.

In one implementation, the method comprises requesting device information from the plurality of user equipment (UEs) within a coverage area of a wireless network, such as for example, Wi-Fi, Bluetooth, etc., and receiving the requested device information from the plurality of UEs. Further, the backhaul cellular capability may include cellular internet service independent from the broadband internet connectivity. For example, the backhaul cellular capability may comprise a cellular hot spot connection.

The backhaul connectivity via the one or more UEs that have the backhaul cellular capability may be further established by: sending an internet backhaul mode activation request to the selected UE, and receiving backhaul access credentials from the selected UE, subsequent to activation of the internet backhaul mode by the selected UE. The requested device information from the plurality of user equipment (UEs) may comprise information indicating strength of the backhaul cellular capability of each of the plurality of UEs.

For example, the requested device information may comprise one or more of: device type, signal strength, available bandwidth, bit rates of data packets received by devices, and number of antennas. The one or more UEs of the plurality of UEs that have the backhaul cellular capability may be ranked based on received information indicating strength of the backhaul cellular capability.

The one or more UEs of the plurality of UEs that have the backhaul cellular capability may be ranked based on received information indicating strength of the backhaul cellular capability. Moreover, the selected UE among the one or more UEs may be a highest ranked UE based on the received information indicating the strength of the backhaul cellular capability.

In addition, the broadband internet connectivity may be provided by a wide area network (WAN). The determination that broadband internet connectivity is abnormal may comprise broadband service outage. The one or more UEs that have cellular internet service independent from the broadband internet connectivity may comprise one or more of: a mobile phone and an electric vehicle (EV).

Another exemplary embodiment includes a broadband service enabler configured to provide access to a wireless network, the broadband service enabler comprising one or more hardware processors configured by machine-readable instructions to: determine that broadband internet connectivity for a plurality of user equipment (UEs) is abnormal; determine that one or more UEs of the plurality of UEs have a backhaul cellular capability; transmit a backhaul request token to a selected UE among the one or more UEs that have the backhaul cellular capability; receive backhaul acceptance from the selected UE among the one or more UEs that has the backhaul cellular capability; and establish backhaul connectivity for the plurality of UEs via the selected UE that has the backhaul cellular capability.

The backhaul connectivity via the one or more UE that have the backhaul cellular capability may be established by requesting the selected UE to: turn off access credentials of the selected UE and operate as the broadband service enabler with access credentials of the broadband service enabler. The broadband service enabler may be a gateway.

Yet another exemplary embodiment includes a non-transitory computer-readable medium storing instructions of a user equipment (UE) that when executed by a processor cause the processor to perform operations comprising: determining that broadband internet connectivity for a plurality of user equipment (UEs) is abnormal; determining that one or more UEs of the plurality of UEs have a backhaul cellular capability; transmitting a backhaul request token to a selected UE among the one or more UEs that have the backhaul cellular capability; receiving backhaul acceptance from the selected UE among the one or more UEs that has the backhaul cellular capability; and establishing backhaul connectivity for the plurality of UEs via the selected UE that has the backhaul cellular capability.

### BRIEF DESCRIPTION OF THE DRAWINGS

These and other more detailed and specific features of various embodiments are more fully disclosed in the following description, reference being had to the accompanying drawings, in which:

FIG. 1A illustrates an exemplary system for a typical broadband connectivity in accordance with various aspects of the present disclosure;

FIG. 1B illustrates an exemplary system for a backhaul connectivity in accordance with various aspects of the present disclosure;

FIG. 2 illustrates an exemplary processing node in accordance with various aspects of the present disclosure;

FIG. 3 illustrates an exemplary process flow for establishing backhaul connectivity in a wireless network;

FIG. 4A illustrates an exemplary process for a typical broadband connectivity in a wireless network;

FIG. 4B illustrates an exemplary process for establishing a backhaul connectivity in a wireless network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

To provide connectivity in the event of broadband Internet failure, there is a need for backhaul connectivity to broadband service users without adding the cost of additional hardware procurement and maintenance solely for backhaul connectivity purposes.

Examples described herein include systems and methods for providing backhaul connectivity for in-home networks without additional hardware. In instances when an in-home network includes a cellular device, such as a mobile phone or a cell ready electric vehicle (EV), the cellular device is utilized for backhaul connectivity, thereby eliminating procurement and maintenance of additional hardware.

A local area network (LAN) of the in-home network may include multiple devices with backhaul cellular capability. In instance when broadband customer premises equipment (CPE) experiences a service outage, there is a need for replacement of the broadband Internet service functionality. One of the LAN devices with cellular connectivity may be engaged and selected to replace the function of the broadband CPE. In addition to determining LAN devices that have cellular connectivity and are backhaul cellular capable, an optimal candidate of the LAN devices may be selected as a replacement for the broadband CPE. The selected LAN device establishes a backhaul cellular connection to provide broadband functionality during the outage.

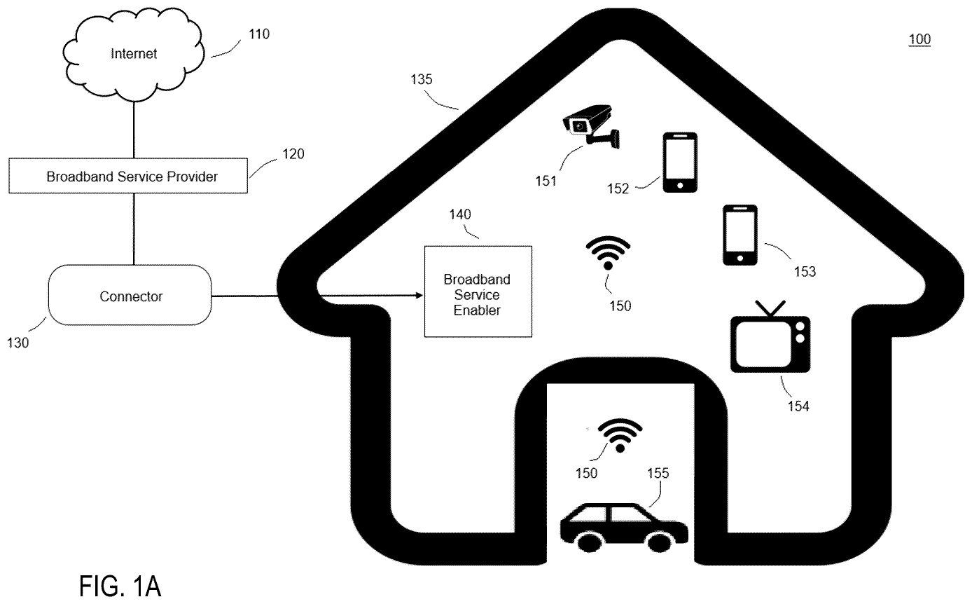

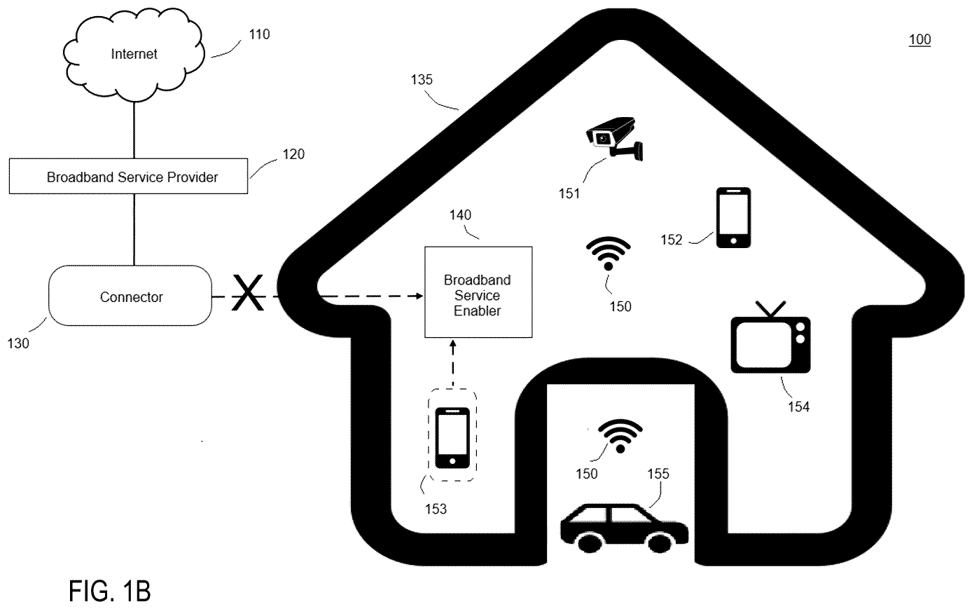

FIG. 1A illustrates an exemplary system for a typical broadband connectivity and FIG. 1B illustrates an exemplary system for a backhaul cellular connectivity in accordance with various aspects of the present disclosure. System 100 includes a broadband service provider 120 that provides access to the internet 110 for a local area network (LAN) 135, such as an in-home or a building network. LAN 135 is connected to a broadband service provider 120 via a connector 130. Connector 130 may be a physical connector, such as fiber optic cable, or fixed wireless access using a 3G/4G/5G wireless network. Fixed wireless access (FWA) is a type of broadband service that provides internet to a specific location, while cellular is a type of internet service that can be used on the go.

Broadband service enabler 140 sends and receives data packets from the broadband service provider 120 via the connector 130 during typical operations of LAN 135, when wide area network (WAN) connectivity is available and uninterrupted. Broadband service enabler 140 may be a broadband CPE that is an internet gateway. System 100 may include user equipment (UE) 151-155 within the LAN coverage that is able to communicate with the broadband service enabler 140. The UE 151-155 may be end-user wireless devices and may be connected to operate within LAN 135 that communicates with the broadband service provider 120 via connector 130. The LAN 135 may be a home or a business internet network, and UE 151-155 may be connected to a mesh WiFi 150, provided by the broadband service enabler 140. Mesh WiFi 150 may use multiple devices to create a single LAN network that provides WiFi coverage throughout a home or office.

In one implementation, UE 152, 153 and 155 are devices with cellular capability. Devices with cellular capability include mobile phones, EVs, or other devices with cellular hotspot capability. UE 151 and 154 do not have cellular capability and are unable to communicate with the internet 110 apart from the service enabler 140.

UE 151-155 share information such as device type (e.g., “MobilePhone” or “InternetGatewayDevice,” or “RedCapDevice,”), signal strength (e.g., received signal strength indicator (RSSI)), available bandwidth (upload and download), bit rates of data packets received by individual devices, number of antennas (e.g., single versus MIMO) with broadband service enabler 140. Additionally, UE 151-155 can share the data packets with each other upon request and approval using WiFi or Bluetooth.

FIG. 1B is an exemplary system for a backhaul cellular connectivity upon loss of broadband connectivity in accordance with various aspects of the present disclosure. Subsequent to the loss of broadband connectivity, broadband service enabler 140 communicates to UE 151-155 to establish backhaul cellular connectivity independent from the broadband service provided by the service enabler 140.

Service enabler 140 requests information from UE 151-155 such as device type, signal strength, available bandwidth, bit rates of data, and number of antennas. UE 151-155 are scored for backhaul cellular connection capability. A processor of broadband service enabler 140 is configured to receive the input from UE 151-155 to score backhaul cellular connection capability and which of UE 151-155 to use for backhaul cellular connection to replace the lost connection with the broadband service provider 120. In one implementation, the service enabler 140 connects with newly added devices to the LAN, such as guest devices, subsequent to the loss of connection with the broadband service provider 120 to score backhaul cellular connection capability for guest devices.

Processor of service enabler 140 determines which of UE 151-155 available within LAN 135 are backhaul cellular capable. In addition, the service enabler 140 scores and ranks the devices in terms of being strong candidates for a backhaul cellular connection. For example, the service enabler 140 may determine that highly ranked devices have a cellular connection with a strong signal, a large bandwidth available and a MIMO antenna system. UE 151-155 are ranked based on device type, signal strength, available bandwidth, bit rates of data, and number of antennas to determine the best device candidates(s) to establish a quality and reliable backhaul cellular connection. Once UE 151-155 are scored and ranked, the service enabler 140 may send a request to the best candidate to activate a backhaul cellular connection to reestablish Internet connectivity. In the example shown in FIG. 1B, device 153 is scored and ranked as the best candidate for backhaul cellular connection. Service enabler 140 sends a request to UE 153 to establish a backhaul cellular connection. For example, the service enabler 140 may transmit a backhaul request token to UE 153 as the selected best candidate.

Upon acceptance of the request, UE 153 shares a service set identifier (SSID) and password broadband service enabler 140 to establish a backhaul cellular connection using a connection mode such as hotspot. If UE 153 rejects the request, the service enabler 140 proceeds to the next best candidate by passing the backhaul request token to the next candidate until a suitable UE with a backhaul cellular capability accepts the request and a backhaul cellular connection is established. A device may reject a request due to the high cost of sharing cellular data with other devices in LAN 135 or a may have a low data cap.

Once the broadband service enabler 140 receives approval, the backhaul cellular connection is established via a wireless device in LAN 135 (UE 153 in FIG. 1B, for example). UE 153 assumes the function of providing internet service that was previously provided service enabler 140 using broadband service provider 120. Accordingly, the service enabler 140 regains internet access for the remaining wireless devices in LAN 135.

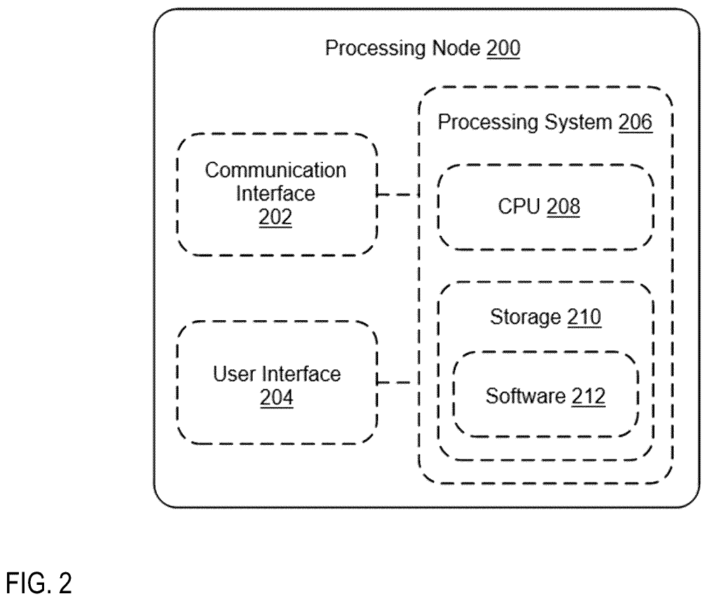

FIG. 2 depicts an exemplary processing node 200 useful for managing backhaul cellular connection in a wireless network. The processing node 200 includes a communication interface 202, user interface 204, and processing system 206 in communication with communication interface 202 and user interface 204. Processing system 206 includes a microprocessor 208, storage 210, which can comprise a disk drive, flash drive, memory circuitry, or other memory device including, for example, a buffer. Storage 210 includes software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200.

In an exemplary embodiment, software 212 can include instructions for determining whether WAN connectivity is abnormal or disabled and sending a request for device information to devices within the LAN. The instructions may further include processing and comparing the information received from the devices. The instructions may further include determining that the device is an optimal candidate for a backhaul cellular connection among the available devices. The instructions may further include sending a backhaul request to the optimal candidate and establishing a backhaul connection.

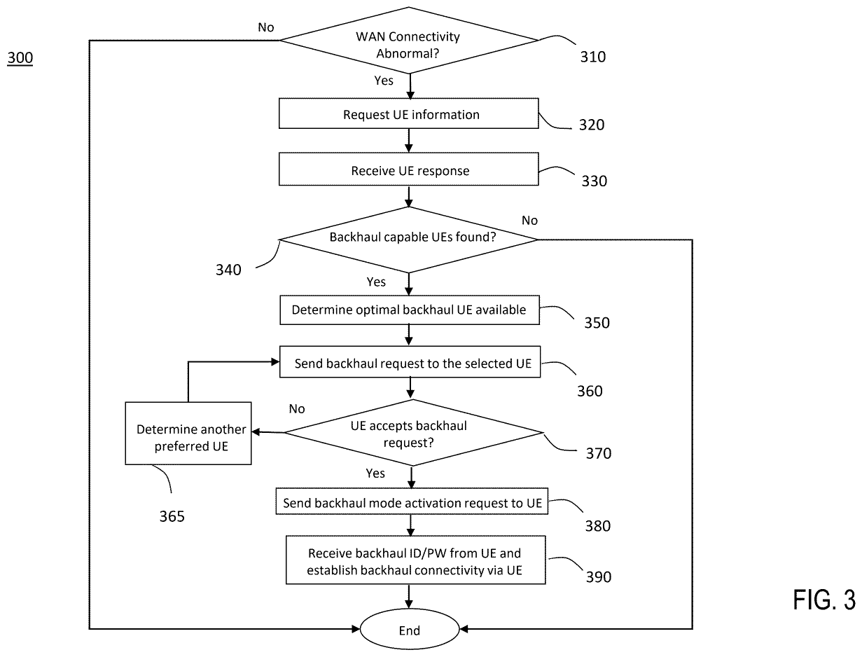

FIG. 3 illustrates an exemplary method 300 for establishing and managing a backhaul connection in a LAN network. Method 300 may be performed by any suitable combination of processors, such as processing node 200. Although FIG. 3 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

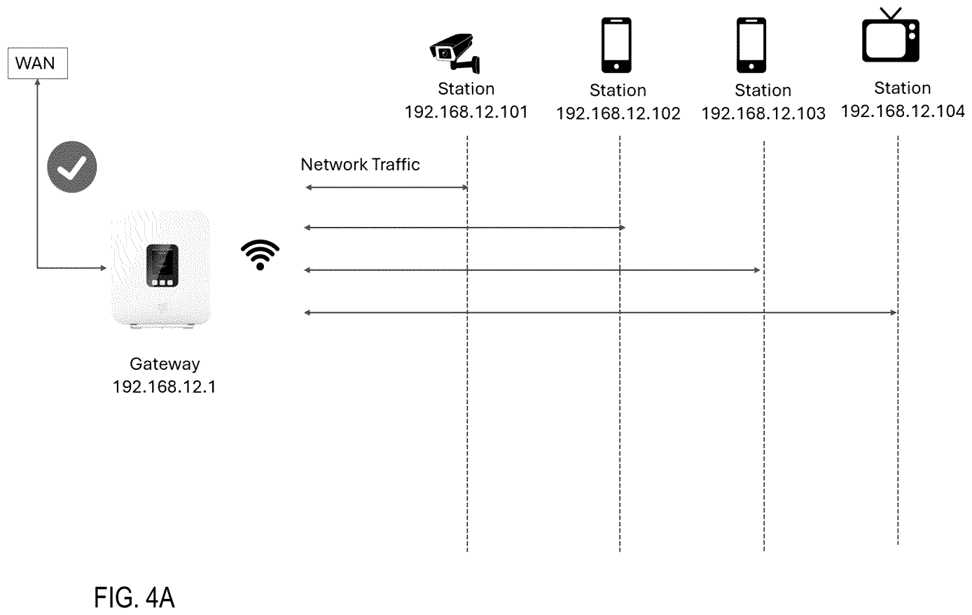

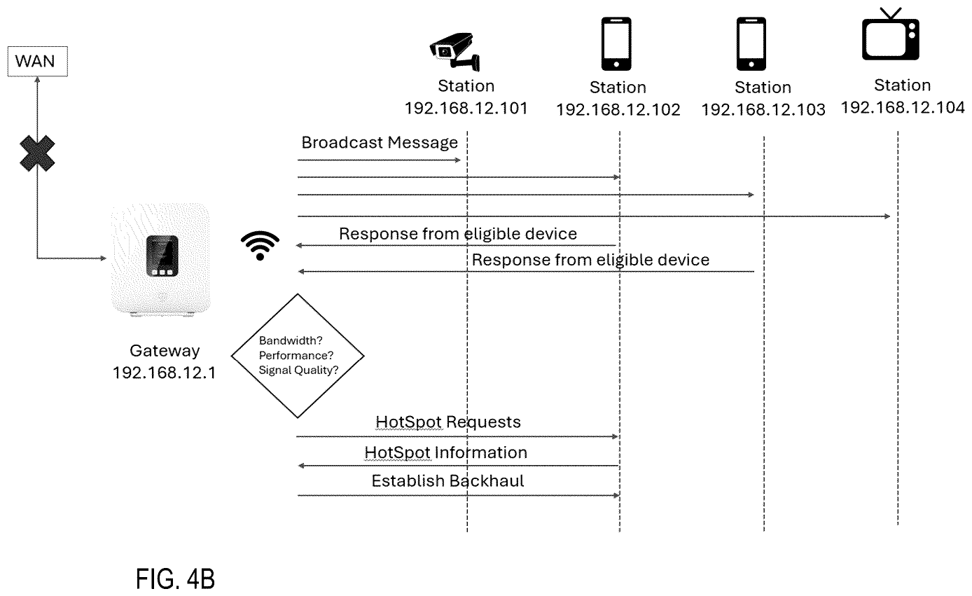

Method 300 begins at step 310 where it is inquired whether a normal WAN connectivity is disrupted or abnormal. In instances where the WAN connectivity functions normally, the broadband service enabler 140 is in communication with the broadband service provider 120, as shown in FIG. 1A and FIG. 4A. Accordingly, the UE 151-155 within LAN 135 are provided with internet access by the broadband service enabler 140 via the connector 130. In the example shown in FIG. 4A, the broadband service enabler is a gateway connected to WAN. The gateway is assigned with a private IP address for managing the LAN. At the same time, the wireless devices within the LAN are also assigned with corresponding private IP addresses within the LAN in order to communicate with the gateway and to send and receive network traffic.

However, if the service enabler 140 determines that there is broadband Internet failure (see FIGS. 1B and 4B), in step 320, the service enabler 140 broadcasts a message requesting information from the UE that are within the LAN coverage.

The requested information may include device type (e.g., “MobilePhone” or “InternetGatewayDevice,” or “RedCapDevice,”), signal strength (e.g., received signal strength indicator (RSSI)), available bandwidth (upload and download), bit rates of data packets received by individual devices, number of antennas (e.g., single versus MIMO) or any other information that the processor of the service enabler 140 may use to evaluate backhaul cellular capability of each UE.

Subsequent to each UE receiving the request from the service enabler 140, the UEs send the pertinent information and the service enabler 140 receives the requested input. In step 340, the system determines whether any backhaul cellular capable devices are detected. For example, the system inquiries whether there are any wireless devices present with their own separate cellular service, e.g., with access to a 3G/4G/5G network independently from the service enabler 140. In the implementation shown in FIG. 4B, the eligible devices respond to the broadcast from the service enabler 140 and the ineligible devices may provide a negative acknowledgment (NAK) response or no response at all.

If the system determines that backhaul cellular capable devices are present, the processor of the service enabler 140 ranks the backhaul cellular capable devices in step 350, assuming that more than one device is found (e.g., in FIG. 1B, two mobile phones and one EV are available, and in FIG. 4B, two mobile phones produce a response). The information received from the UEs is processed to rank and order the UEs in terms of being strong backhaul candidates. If a single eligible device is detected, such device is designated for cellular backhaul connectivity replacement of the disrupted WAN access. The criteria used for ranking may be device type (e.g., “MobilePhone” or “InternetGatewayDevice,” or “RedCapDevice,”), signal strength (e.g., received signal strength indicator (RSSI)), available bandwidth (upload and download), bit rates of data packets received by individual devices, number of antennas (e.g., single versus MIMO) and/or any other factors that have a potential to establish a quality and reliable backhaul connection.

The service enabler 140 may include a processor configured to use the information received from each device to compute a score for each device and create a score list for the UEs. The processor may be configured to receive the input from the UEs in order to make a determination as to which of the UEs to select from for a backhaul connection to replace the lost connection with the broadband service provider 120. Such determination may be performed according to the scores calculated for each device within the LAN coverage.

Upon ascertaining and selecting the highest ranked backhaul cellular capable device, the service enabler 140 sends a backhaul (e.g., hotspot) request to the selected UE in step 360. For example, the service enabler 140 may transmit one or more backhaul request tokens to the selected UE until one of the selected UE accepts the cellular backhaul request.

In step 370, the service enabler 140 determines whether the selected UE accepted the request, or, in certain implementations, whether the selected UE has a default backhaul configuration set to “Yes.” In some instances, however, the top ranked UE may reject the request for a variety of reasons. For example, due to a high cost or a low data cap of cellular data that the device uses independently from the Wi-Fi network, the selected UE may refuse to share the data with the other devices within the LAN network via a gateway. Accordingly, in step 365, the system proceeds down the list of the highest ranked devices sending another request to the next best backhaul candidate.

As one of the eligible UEs accepts the request from the service enabler 140, and provides a notification of approval, in step 380, to the service enabler 140 sends another request to the accepting UE to activate the internet backhaul mode. In one implementation, prior to the request to activate the internet backhaul mode, the broadband service enabler 140 sends a message to the accepting UE to activate the cellular service that the UE has access to independent from the broadband service provided by the service enabler 140.

In response to the request, the UE shares encrypted backhaul credentials, such as an ID and a password with the service enabler 140. As the service enabler 140 receives the access credentials in step 390, the service enabler 140 provides acknowledgment to the UE, the UE turns on the internet backhaul mode and the gateway establishes backhaul connectivity via the UE. In one embodiment, the service enabler 140 requests the UE to turn off the UE's access credentials and to operate as the broadband service enabler 140 with the access credentials of the broadband service enabler 140. As a result, the UE steps in for the broadband service provider 120 for the duration of the WAN outage, or as long as the backhaul UE maintains access permission to the LAN users.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
determining that broadband internet connectivity for a plurality of user equipment (UEs) is abnormal;
determining that one or more UEs of the plurality of UEs have a backhaul cellular capability;
transmitting a backhaul request token to a selected UE among the one or more UEs that have the backhaul cellular capability;
receiving backhaul acceptance from the selected UE among the one or more UEs that has the backhaul cellular capability; and
establishing backhaul cellular connectivity for the plurality of UEs via the selected UE that has the backhaul cellular capability.

2. The method of claim 1, further comprising:
requesting device information from the plurality of user equipment (UEs) within a coverage area of a wireless network; and
receiving the requested device information from the plurality of UEs.

3. The method of claim 1, wherein the backhaul cellular capability comprises cellular service independent from the broadband internet connectivity.

4. The method of claim 3, wherein the backhaul cellular capability comprises a cellular hot spot connection.

5. The method of claim 4, wherein the backhaul connectivity via the one or more UE that have the backhaul cellular capability is further established by:
sending an internet backhaul mode activation request to the selected UE; and
receiving backhaul access credentials from the selected UE, subsequent to activation of the internet backhaul mode by the selected UE.

6. The method of claim 2, wherein the requested device information from the plurality of user equipment (UEs) comprises information indicating strength of the backhaul cellular capability of each of the plurality of UEs.

7. The method of claim 6, wherein the requested device information comprises one or more of: device type, signal strength, available bandwidth, bit rates of data packets received by devices, and number of antennas.

8. The method of claim 6, wherein the one or more UEs of the plurality of UEs that have the backhaul cellular capability are ranked based on received information indicating strength of the backhaul cellular capability.

9. The method of claim 5, wherein the one or more UEs of the plurality of UEs that have the backhaul cellular capability are ranked based on received information indicating strength of the backhaul cellular capability; and
wherein the selected UE among the one or more UEs is a highest ranked UE based on the received information indicating the strength of the backhaul cellular capability.

10. The method of claim 1, wherein the broadband internet connectivity is provided by a wide area network (WAN), and
wherein the WAN comprises at least one of: a cable internet service, a satellite internet service and a fiber internet service.

11. The method of claim 1, wherein the determination that broadband internet connectivity is abnormal comprises broadband service outage.

12. The method of claim 2, wherein the one or more UEs that have cellular internet service independent from the broadband internet connectivity comprise one ore more of: a mobile phone and an electric vehicle (EV).

13. A broadband service enabler configured to provide access to a wireless network, the broadband service enabler comprising one or more hardware processors configured by machine-readable instructions to:
determine that broadband internet connectivity for a plurality of user equipment (UEs) is abnormal;
determine that one or more UEs of the plurality of UEs have a backhaul cellular capability;
transmit a backhaul request token to a selected UE among the one or more UEs that have the backhaul cellular capability;
receive backhaul acceptance from the selected UE among the one or more UEs that has the backhaul cellular capability; and
establish backhaul connectivity for the plurality of UEs via the selected UE that has the backhaul cellular capability.

14. The broadband service enabler of claim 13, wherein the instructions further comprise:
requesting device information from the plurality of user equipment (UEs) within a coverage area of a wireless network; and
receiving the requested device information from the plurality of UEs.

15. The broadband service enabler of claim 13, wherein the backhaul cellular capability comprises cellular internet service independent from the broadband internet connectivity.

16. The broadband service enabler of claim 15, wherein the backhaul cellular capability comprises a cellular hot spot connection.

17. The broadband service enabler of claim 16, wherein the backhaul connectivity via the one or more UE that have the backhaul cellular capability is further established by requesting the selected UE to:
turn off access credentials of the selected UE, and
operate as the broadband service enabler with access credentials of the broadband service enabler, wherein the broadband service enabler is a gateway.

18. The broadband service enabler of claim 14, wherein the requested device information from the plurality of user equipment (UEs) comprises information indicating strength of the backhaul cellular capability of each of the plurality of UEs.

19. The broadband service enabler of claim 18, wherein the requested device information comprises one or more of: device type, signal strength, available bandwidth, bit rates of data packets received by devices, and number of antennas.

20. A non-transitory computer-readable medium storing instructions of a user equipment (UE) that when executed by a processor cause the processor to perform operations comprising:
determining that broadband internet connectivity for a plurality of user equipment (UEs) is abnormal;
determining that one or more UEs of the plurality of UEs have a backhaul cellular capability;
transmitting a backhaul request token to a selected UE among the one or more UEs that have the backhaul cellular capability;
receiving backhaul acceptance from the selected UE among the one or more UEs that has the backhaul cellular capability; and
establishing backhaul connectivity for the plurality of UEs via the selected UE that has the backhaul cellular capability.
